(19) United States
(12) Patent Application Publication
(10) Pub. No.: US 2011/0238550 A1
(43) Pub. Date: Sep. 29, 2011

(54) SYSTEMS AND METHODS FOR PREDICTING FINANCIAL BEHAVIORS

(76) Inventors: Joshua Reich, Brooklyn, NY (US); Shamir Karkal, Bangalore (IN)

(21) Appl. No.: 13/070,938

(22) Filed: Mar. 24, 2011

Related U.S. Application Data
(60) Provisional application No. 61/316,984, filed on Mar. 24, 2010.

(51) Int. Cl. G06Q 40/00

(52) U.S. Cl. 705/35

(57) ABSTRACT

A system and method for predicting financial behaviors of the consumers and utilizing this predicted data to assist consumers in managing their accounts and find other consumers. The systems and methods of the present invention provides for receiving consumers transactions and clustering the transactions to compute a similarity measure and further predicting future transactions based on the similarity measure of the clustered transactions. These predictive future transactions are further computed to generate a predictive behavior model which provides predictive financial behaviors of the consumers. Some of the uses of this system and method include assisting users by warning them of impending problems, optimally routing transactions, suggesting financial products and identifying particular behavior patterns for personal goal achievement and self directed behavior modification.

### CROSS-REFERENCE TO RELATED APPLICATION

This application claims benefit of United States Provisional Patent Application No. 61/316,984, titled “System and Method for Predicting Financial Behaviors”, filed Mar. 24, 2010, the entire disclosure of which is incorporated herein by reference.

### FIELD OF THE INVENTION

The present invention relates generally to a method and system for predicting financial behaviors, and more particularly to analyzing personal historical consumer financial behavior to accurately predict future financial behaviors and use the predicted data to assist consumers in optimizing their use of financial products.

### BACKGROUND OF THE INVENTION

Consumers are plagued by a number of shortcomings in the way financial institutions currently use consumer's financial transaction data. For example, consider an account holder with an available balance of $100. Under the status quo, the financial institution does not warn the account holder if a bill payment of $200 is scheduled for the following day despite the fact that an overdraft is likely. In another example, consider a sophisticated consumer who has spread his/her assets over a number of different interest bearing accounts. If he/she wishes to fund an extraordinary expense, such as a holiday, or other related expenditures, he/she must manually determine the best source of funding, taking into account not only the interest rates on all of his/her accounts, but also the respective sets of terms and conditions attached to each account. Such a decision is further complicated if the accounts are spread among multiple financial institutions, which can introduce delays and costs in transferring money among institutions.

Currently, many consumer banking transactions follow a semi-regular pattern. Typically the pattern includes activities such as receiving income on particular dates and making payments on dates following the receipt of income and daily cash withdrawals. These activities tend to moderate themselves with respect to remaining balance. The periodicity of these withdrawals depends on geography, varies by demographic, and is ultimately driven by each individual's utility. For example, consumers typically make certain purchases on a fairly regular basis, such as, for example, purchases made at their local grocery stores, supermarkets and butchers. At other times, however, a consumer may engage in atypical spending activity, such as an entertainment or restaurant purchase. Such transactions may disrupt or delay the otherwise regular grocery shopping behavior. Whereas, some consumers may tend to eat food home more often than others, thus varying the timing of food-related transactions as compared to others. Financial institutions that process these retail payments see a near real-time view of consumer transactions. However, these transactions are typically stored in database systems and merely support accounting and regulatory operations. Further, the transactions are a complex and highly interconnected reflection of real world consumer behaviors.

Thus, there is a need in the art to address various problems facing consumers that are ill-suited to make complex financial decisions. Also, there is a need in the art to analyze the consumer transactional data to identify predictable consumer behavioral patterns. Further, there is a need in the art to provide a simpler system and method for predicting such future financial behaviors wherein real-world behaviors present themselves as transactions in real time.

### SUMMARY OF THE INVENTION

Embodiments of the present invention provide for systems and methods for predicting financial behaviors of the consumers and use this predicted data to'assist consumers in managing their accounts and find other consumers.

According to one embodiment of the present invention, there is provided a system and computer-implemented method for predicting future financial behaviors of a consumer. The method comprising (a) receiving a plurality of consumer financial transactions; (b) identifying a set of similar transactions among the plurality of the consumer financial transactions based on one or more pre-defined coefficients; and (c) clustering the set of similar transactions. The method also comprising (d) partitioning the consumer financial transactions into a first data set and a second data set, wherein the first data set comprises a first period of the consumer financial transactions and the second data set comprises a second period of the consumer financial transactions; (e) deriving clustered transactions from the first data set of the financial transactions; and (f) generating random future financial transactions based on transactional details of each of the clustered transactions in the first data set. The method further comprising (g) comparing transactional details of the random future financial transactions with the , transactions in the second data set to compute a first score; (h) determining that the random future financial ,transactions comprise predictive future financial transactions if the first score is less than a first pre-defined threshold value; (i) updating the one or more pre-defined coefficients if the first score is greater than the first predefined threshold value; and repeating steps (b) through (i).

According to another embodiment of the present invention, there is provided a system and computer-implemented method for predicting future financial behaviors of a consumer based on financial behaviors of friends of the consumers.

According to another embodiment of the present invention, there is provided a system and method for using the predicted financial behaviors to route transactions of the consumers.

According to even another embodiment of the present invention, there is provided a system and method for using the predicted financial behaviors to select new financial products for the consumers.

According to a further embodiment of the present invention, there is provided a system and method for using the predicted financial behaviors to assist the consumers in reaching financial goals.

### BRIEF DESCRIPTION OF THE DRAWINGS

The present invention will be more readily understood from the detailed description of exemplary embodiments presented below considered in conjunction with the attached drawings, of which:

FIG. 1 is a block diagram illustrating components of an exemplary predictive financial behavior system architecture, according to one or more embodiments of the present invention;

FIG. 2 is a flow chart illustrating steps of an exemplary process for predicting future consumer financial behaviors according to one or more embodiments of the present invention; and

FIG. 3 is a flow chart detailing the steps of an exemplary process for determining an accuracy of an exemplary consumer approach, according to one or more embodiments of the present invention;

FIG. 4 is a flow chart illustrating steps of an exemplary process for predicting future financial behaviors of consumers, according to an embodiment of the present invention;

FIG. 5 is a flow chart illustrating steps of an exemplary process for using the predicted future financial behaviors of consumers to route transactions, according to another embodiment of the present invention;

FIG. 6 is a flow chart illustrating steps of an exemplary process for using the predicted future financial behaviors of consumers to select new financial products, according to one or more embodiments of the present invention;

FIG. 7 is a flow chart illustrating steps of an exemplary process for using the predicted future behaviors of consumers to assist the consumers in reaching financial goals, according to a further embodiment of the present invention.

It is to be understood that the attached drawings are for purposes of illustrating the concepts of the invention and may not be to scale.

### DETAILED DESCRIPTION OF THE INVENTION

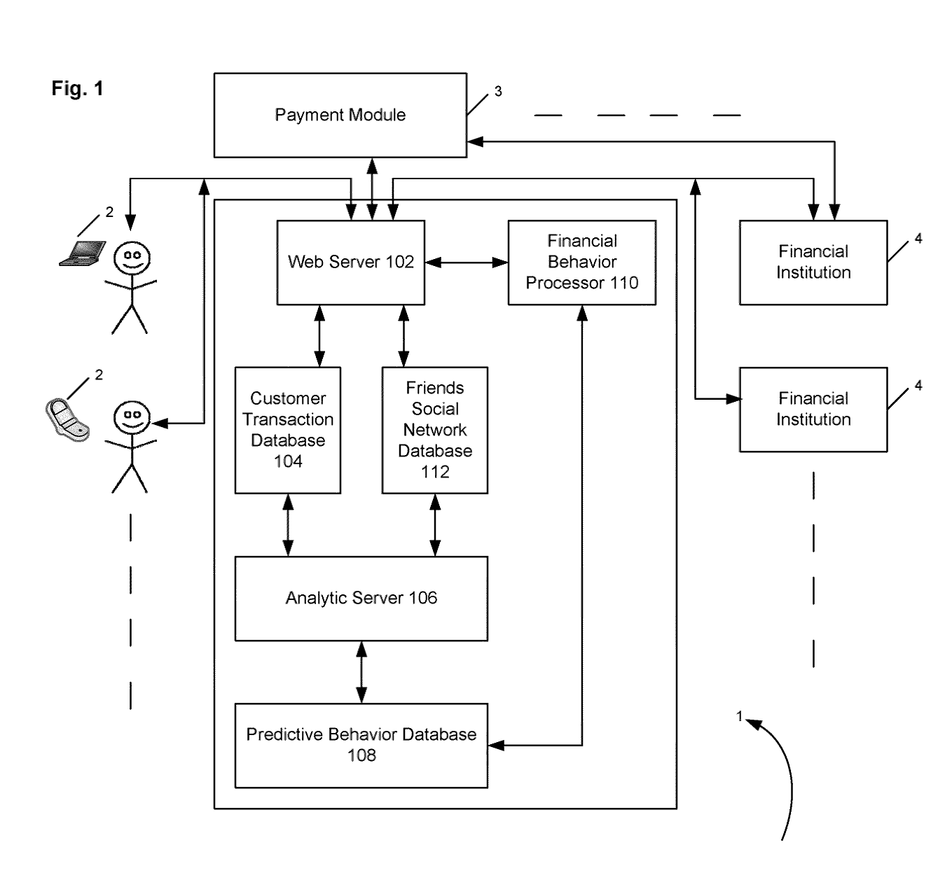

The present invention relates to a method and a system for predicting financial behaviors (the system herein referred to as the “Predictive Financial Behavior System” or “PFBS). As used herein, the term “financial behavior” is intended to include, but is not limited to, a consumer's periodic (e.g. weekly) spending patterns, frequency of vacations, risk preferences, etc. FIG. 1 depicts the PFBS 1 according to embodiments of the present invention. The PFBS 1 is a computer-based system, accessible by one or more “users” (via “user devices 2) associated with one or more consumers who have been granted the necessary authorization and access to the Predictive Financial Behavior System 1. As used herein, the term “user” is intended to include, but is not limited to, any consumer, a friend of a consumer, client or other person, associated with a financial institution. As used herein, the term “financial institution” is intended to include, but is not limited to a bank, credit union, trust company, mortgage loan company, insurance company, or the like, and the related computing environment configured to include and/or have access to the PFBS 1. The term “user device” is intended to include, but is not limited to any computer device such as a cell phone, a tablet, e.g. Apple iPad™, Smartphone, a personal digital assistant, a desktop computer, personal computer, laptop or any other device, that is configured to access the PFBS I. The term “computer” is intended to include any data processing device, such as a desktop computer, a laptop computer, a mainframe computer, a personal digital assistant, a server, a handheld device or any other device configured to process data. The PFBS I is also accessible by one or more payment modules 3 used by or associated with a consumer which also has been granted the necessary authorization and access rights. As used herein, the term “payment modules” is any device network system, computer or means by which a user may make a payment relating to a transaction. Exemplary payment modules may include automated teller machine (ATM) networks, credit cards, or other charge cards associated with a financial institution. The term “computer module” is intended to include, but is not limited to, one or more computers configured to execute one or more software programs configured to perform one or more functions.

According to an embodiment of the present invention, the PFBS I is configured to predict future financial behaviors and evaluate the predicted behavior (i.e. predicted data) to help consumers better analyze their finances and use them to maximize their beneficial utility from their financial institutions. As shown in FIG. 1, the PFBS 1 comprises a web server 102, a consumer transaction database 104, an analytics server 106, a predictive behavior database 108, a financial behavior processor 110 (herein the “processor”) and a friends social network database 112. The aforementioned components of the PFBS 1 represent computer-implemented hardware and software modules configured to perform the functions described in detail below. One having ordinary skill in the art will appreciate that the components of the Predictive Financial Behavior system 1 may be implemented on one or more communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers. According to an embodiment of the present invention, the components of the PFBS 1 may each be a computer module particularly configured to perform the function associated with the respective components as described below.

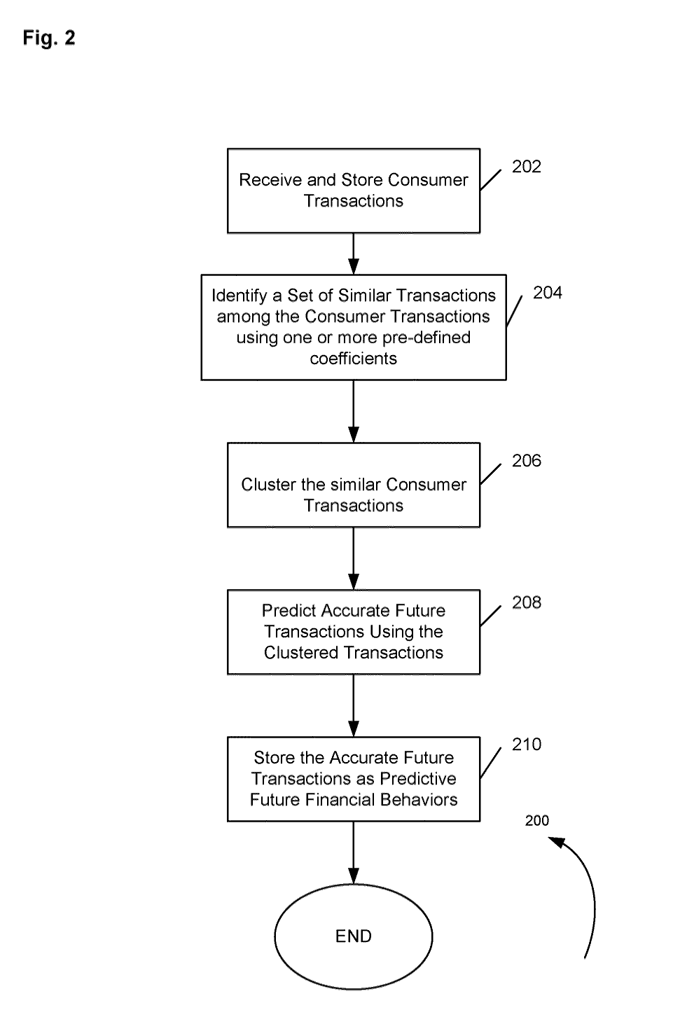

The features and functionality of the PFBS 1 and its components are described in detail in connection with the system diagram of FIG. 1 and the process flow diagrams presented in FIGS. 2-7. With reference to FIG. 1, the web server 102 presents a user friendly application to access consumer initiated financial transactions from one or more consumer devices 2, payment modules 3 and one or more financial institutions 4. The details of the components of FIG. 1 are described herein below.

The web server 102 of the PFBS 1 in FIG. 1 is configured to receive consumer identification data including the consumer transactions from one or more of consumer devices 2, payment modules 3, and the financial institutions 4. The consumer identification data and their corresponding transaction data are stored in the consumer transactions database 104. The consumer identification data includes, but is not limited to a consumer's name, age, sex, social security number, address, income or other suitable identifying information. Some consumer transactions include, but are not limited to deposits, cash withdrawals, making payments, purchasing goods and/or services etc. The analytic server 106 of the PFBS I periodically accesses the consumer transactions from the consumer transactions database 104 to generate and update predictive future financial behaviors stored in the predictive behavior database 108. The financial institutions 4 are computer-based systems communicatively connected to the PFBS and are configured to execute financial transactions which may be received from one or more payment modules 3 or from the web server 102 of the predictive financial behavior system 1 via the web server 102. The processor 110 functions to retrieve friends (who are also consumers) of the consumers 2 identified by the consumers themselves or matches other consumers as friends of the consumers based on some similar demographic data stored in the consumer transaction database 104 or financial behaviors stored in the predictive behavior database 108. The friend identification data and their corresponding transaction data are stored in the social network database 112. Through this mechanism, PFBS 1 receives and transmits transactional information both from the payment module 3 and one or more financial institutions 4, as well as directly from the user devices 2.

FIG. 2 illustrates a method 200 for predicting future financial behaviors in accordance with an embodiment of the present invention. The method 200 begins with step 202 wherein the web server 102 receives consumer financial transactions and stores the related data in the consumer transactions database 104. The consumer transactions data may be received directly from one of the consumer devices 2, the payment modules 3, the financial institutions 4 or a combination of the same. Some of the consumer transactions data include but are not limited to, deposits, cash withdrawals, payments, purchases of goods and/or services, etc. Then, at step 204, each of the consumer transactions are evaluated to identify similarities among them using a set of pre-defined coefficients. These set of pre-defined coefficients measure or rate the relative importance of similarity of each transactional detail in the consumer transactions. The transactional details include a combination of transaction amounts, the institution where the transactions originated the location of the originator and the consumer, periodicity between transactions and combinations thereof.

So, for example, in order to compare $100 transaction compared to two different transactions of $98 and $50 transactions respectively, the details of each of the $98 and the $50 transactions would be required for the comparison. Such transaction details may include such as the timing of each of the transactions, the recipient of the transactions, or the source of the funds. So, all these transactional details are preferably combined when computing the similarity of the two transactions.

The similar consumer transactions generated in step 204 are then clustered by the analytic server 106 in the next step 206. The clustering of the transactions utilizes a clustering algorithm comprising grouping together similar transactions as a proxy for real world behaviors. As known by one skilled in the art, there are many different types of clustering algorithms. As an example, the present invention employs any one of known existing K-means clustering algorithms or hierarchical tree algorithms as described by Li. Wenchao, Zhou Yong and Xia Shixiong in “A Novel Clustering Algorithm Based on Hierarchical and K-means Clustering” in IEEE Control Conference 2009, pages 605-609. An example of the present invention employs the K-means clustering algorithm; an /V number of transactions are grouped together into K clusters such that some similarity metric of intra-cluster members is maximized. Embodiments of the present invention preferably use the combination of the transaction details (such as amount, descriptions, and periodicity as described above) to calculate a similarity measure between the transactions. So, given the O(N̂2) pairs of transactions, a similarity matrix is calculated, where each element ij represents the similarity between transaction 0<i<=N and transaction 0<j<=N. As mentioned above, any one or a combination of existing clustering algorithms such as the k-means method or hierarchical tree algorithms can be used to produce candidate clusterings for the N transactions. The clustering algorithm also recognizes that some transactions are essentially random, i.e. they are not being driven by a clustered behavior. So, for transaction that fails to fit within the cluster, are held aside in a pool of other transactions which preferably share the only similarity of their unpredictable nature.

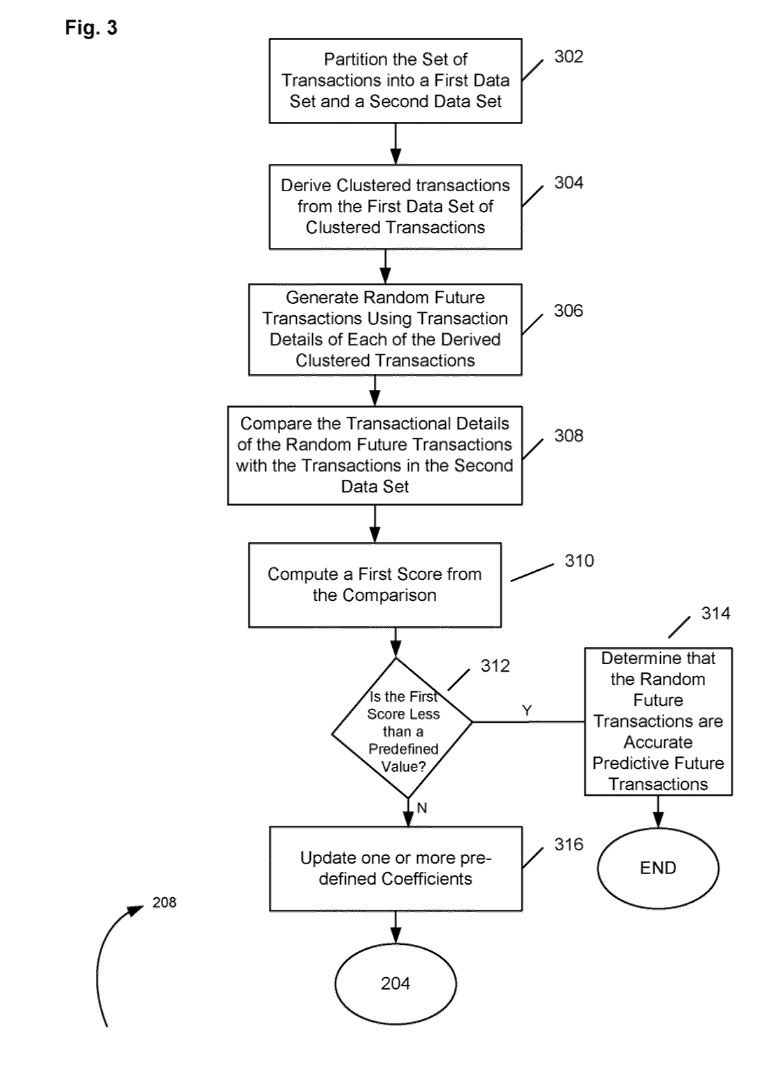

The accuracy of the clustering performed in step 206 is determined by the ability to accurately predict future financial behaviors. Thus, at step 208, accurate future predictions are computed by the analytic server 106 from the clustered transactions generated at step 206. Step 208 is described in detail below with reference to the process flow chart of FIG. 3.

With reference to FIG. 3, an incoming data of transactions is partitioned into first and second data sets at step 302. The first data set of the clustered transactions includes all of consumer transaction history during a first period which is up until some pre-defined date in the recent past. The second data set includes the remaining transactions of the consumers during a second period which is from the pre-defined date in the past through today or a current date. So, this pre-defined date may preferably be a previous day, week, quarter or even year. Then at step 304, clustered transactions are derived from the first data set of transactions. Once clustered transactions have been found, at step 306, random possible future transactions are generated using the transactional details contained within the each of the derived clustered transactions. These random possible future transactions are generated using the method of Monte Carlo simulation. Monte Carlo simulation is a well-known method, dating back to the 1930s. For an overview of its application in finance, see Bruno Dupire “Monte Carlo: Methodologies and applications for pricing and risk management” in Risk Books 1998. Following this step, a time series comparison metric is calculated at step 308 to evaluate/compare transactional details between each random possible future transaction against the data held in the second set of transactions, i.e. the actual future behaviors of the consumer s based on the pre-defined date. The comparison results in a score computed at step 310 which measures the similarity of the simulated transactions with the actual transactions from the second set. A lower score indicates that the predictions from step 306 are more similar to the actual transactions from the second set. Then, at step 312, the score is evaluated or compared with a first pre-defined value. If at step 312 it is determined that the first score is less than a first pre-defined value, then the random possible future transactions are confirmed to be accurate future predictions at step 314. However, if the first score is greater than the first pre-defined value, then at step 316, then the pre-defined coefficients that convert the transactional details into a similarity measure are refined or updated in step 204. These coefficients are updated to derive more accurate clusters in order to generate more accurate future predictions. Coefficients are updated by applying gradient descent methods, which adjust the coefficients and then re-evaluate the quality of the predictions by returning to step 302. As new coefficients are explored, the system keeps track of the score and attempts to adjust the coefficients in a way that maximizes the similarity of the predicted transactions with those from the second set. Gradient descent methods are well known to those versed in the art, and date back to Newton's method of 1669. An overview of the gradient descent method can be

Returning to the process illustrated in FIG. 2, the accurate future predictions computed by the analytic server 106 at step 208 are then stored in the predictive behavior database 108 as the predictive future financial behaviors. The predictive future financial behaviors include, but are not limited to consumers' typical financial behaviors, such as weekly spending patterns, frequency of vacations, risk preferences, etc.

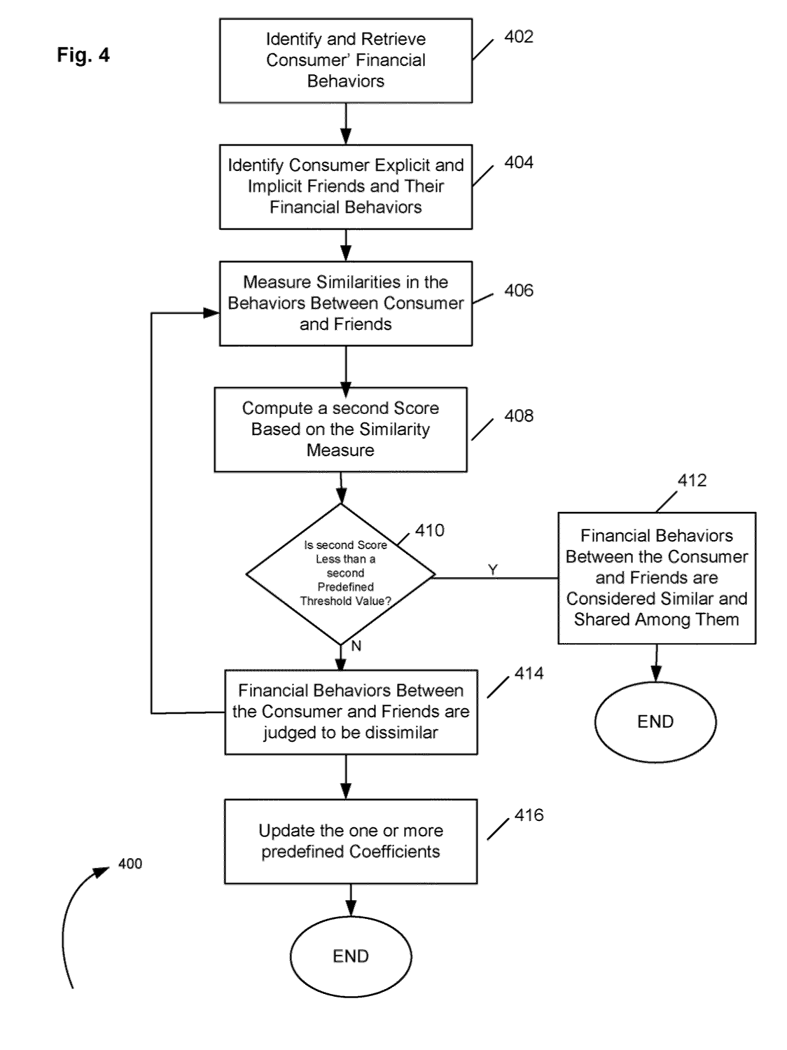

In addition to identifying underlying behaviors based on the consumer financial transaction history, according to another embodiment, the PFBS 1 is also configured to predict future financial behaviors of the consumer by comparing the consumer transactions to those of the friends from the consumer social network database 112, as will be described in greater detail with reference to method 400 illustrated in FIG. 4.

The friends in the consumer social network database 112 are divided into two groups. One such group is the consumer explicit friend network which includes other consumer 2 whom this user has explicitly identified as friends. These friends 2 can be identified and retrieved by the processor 110 by importing from third-party social networks, e.g., for example, Facebook®, MySpace®, Twitter®, GMail®, etc. via the web server 102. Alternatively, the consumer may invite his/her friends to join via the consumer devices 2. When such invited friends join, their identification data are retrieved via the web server 102 and stored in the consumer explicit friend network of the database 112. Another group in the database 112 is the consumer implicit friend social network which includes other consumer s that are implicitly matched to this user. The matching is performed by the processor 110 based on the similarities between the consumer and the user. The processor 110 may preferably use the data stored on the consumer transaction database 104 to match the similarities between the consumers and the user. Such similarity may include demographic information, i.e., consumers who are similar in age, sex, location, income or other demographic criteria. Alternatively, the processor 110 may also match the consumer with the user who share similar financial behaviors stored in the predictive behavioral database 108. For example, the processor 110 may preferably match two consumers 2 who are otherwise unrelated based on the fact that they both buy groceries on the same frequency from similar stores, or that they both take vacations to the same locations. The consumer's social network including the consumer's explicit friends and consumer's implicit friends are stored in social network database 112. Since the consumer friends are the consumers themselves, the friends' financial behaviors are also stored in the predictive behavior database 108.

With reference to FIG. 4, the consumer financial behaviors are identified and retrieved from the predictive behavior database 108. In the next step 404, the consumer explicit and implicit friends are identified and their financial behaviors are also retrieved from the social networks database. In step 406, for each possible pairing of a consumer's behavior and his/her friend's behavior, similarities in financial transactions are measured/calculated using the clustering algorithm described above with respect to FIG. 2. In other words, the behavioral clusters of the consumer and a first friend are scored based on their similarity of transactions, such as, for example, dollar amounts, types of merchants, and temporal patterns. For example, if two behavioral clusters are comprised of transactions close to $100 and occur only on weekends, then they will be considered to be more similar than the two behavioral clusters comprising of transactions with different dollar amounts at different merchants on different days of the month. In step 408, a second score is computed based on the similarity measure. Then at step 410, the second score is compared with a pre-defined second threshold value. If at step 410, the second score is less than a second pre-defined threshold value, then the financial behaviors between the consumer and his/her friend are considered to be similar and are shared between them at step 412. However, if at step 410, the second score is greater than the second pre-defined threshold value, then at step 414, the financial behavioral cluster pairs are judged to be dissimilar and the process is repeated beginning with step 406 for a next possible pairing between the same consumer with another friend on the consumer network. Optionally, the pre-defined coefficients are updated and/or refined in step 416. So, when predicting future financial behavior for an individual consumer, the accuracy of the predictive future transactions or behaviors are limited to the amount of historical data available for that consumer. For example, if there is consumer transaction data available only from January through November of the year 2010 for a consumer, it will be difficult to predict how that consumer will transact over the New Year holiday season. However, if the transaction data from the consumer friends, which encompasses prior holiday seasons, are available, then the processor 110 of the PFBS 1 may preferably infer that friends behave in a similar fashion, and use the friend's behavior to better predict the financial behavior of the consumer.

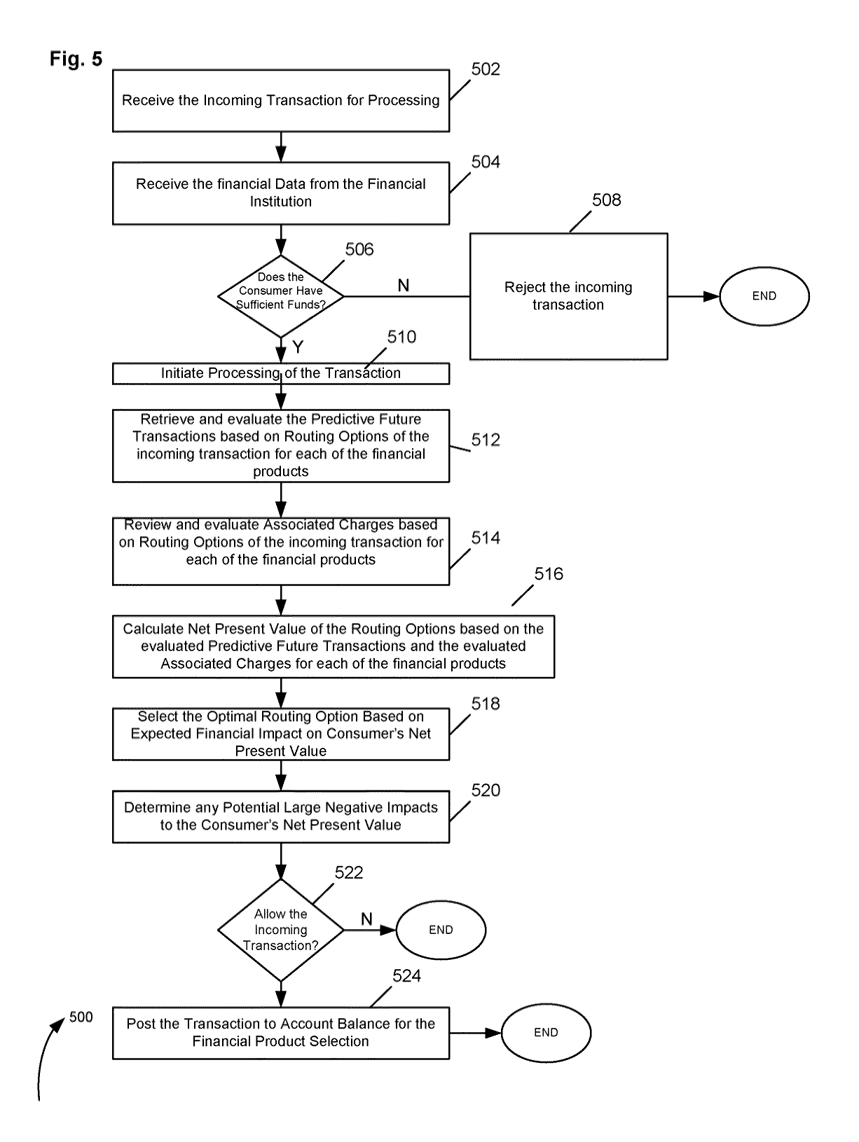

FIG. 5 illustrates a method 500 for routing transactions of the consumer utilizing the future financial behaviors of the consumer stored in the predictive behavior database 108 in accordance with an embodiment of the present application. Beginning with step 502, an incoming transaction is presented for processing to the processor 110 of the PFBS 1 The financial institution 4 stores financial data of each of the consumer financial products, terms, conditions and the total available balance. This available balance includes all positive balances in all the financial products available to the consumer. Some of these financial products include but are not limited to a checking account, line of credit, savings account, term deposit, equity loan, brokerage account, or other financial products. The financial institution 4 then sends the financial data of the consumers' financial products to the processor 110. The financial data is received at step 504 by the processor 110 and using his financial data including the available balance, the processor 110 at step 506 determines if the consumer has enough funds to cover this incoming transaction. If at step 506, it is determined by the PFBS 1 that there are not sufficient funds in one or more of the financial products, the processor 110 immediately rejects the transaction at step 508. However, if at step 506, it is determined by the PFBS 1 that there are sufficient funds; the processor 110 gives permission to initiate processing Of the incoming transaction at step 510. For each of the financial products available to the consumer, the processor 110 then retrieves and evaluates the predictive future transactions from the predictive behavior database for the incoming transaction at step 512.

In step 514, for each of the financial products available to the consumer, the processor 110 evaluates any associated charges such as any associated interest gained or lost by the potential routing options. The routing options are different paths of the financial products available the consumer to direct the incoming transaction. For example, a consumer may have insufficient demand deposit funds to pay for a transaction, but may have term deposits and access to a credit facility. The PFBS 1 functions to make a decision as to whether to break the term deposits or to access a credit line to pay for this particular transaction. In the case of breaking a term deposit, the consumer will forfeit any accumulated interest and possibly will pay a penalty fee. if the purchase is funded by a credit line, the consumer will accumulate an interest charge until the credit is repaid. By having an accurate prediction of the consumer future behavior, the PFBS I may determine which of these two routing options would be the most financially efficient for the consumer. In general, processor 110 simulates what would happen if we were to route the given transaction to each of the consumer's accounts and use the terms and conditions attached to that account to determine the financial impact of that routing option. Each routing option is evaluated on a net present value basis at step 516. Specifically, the processor 110 simulates future financial scenarios under each routing option and iteratively calculates the net cash flows for each day into the future, up to the point where prediction accuracy diminishes below a pre-set threshold value. Then, the processor 110 reviews' the net cash flow on each of those future days and discount these flows back to present value to calculate the net present value of each routing option. Of the various routing options examined, the processor 110 selects the optimal routing option at step 518 based on expected impact on the consumer net present value. In step 520, the processor 110 determines of there are potentially any large negative impacts to the consumer net present value based on the transaction. For example, the consumer may have a zero balance in their checking account, no available credit, but a significant amount of pending interest in a term deposit account, so if an incoming transaction were to be deducted from the term deposit, this would result in a loss of potential interest income. Based on the consumer historical transaction and risk preferences stored in the predictive behavior database 108 and the size of this potential net present value loss, the processor 110 at step 522 determines whether to allow the incoming transaction. So, at step 522, if it is determined that the best transaction routing would result in an excessive net present value loss, the PFBS I would not allow the transaction and thus ending the process. However, if it is determined that the best transaction routing does not cause an excessive net present value loss, then the PFBS 1 allows the incoming transaction and posts the transaction to the account balance for the financial product selection during the routing process at step 524. In other words, the incoming transaction is processed as per normal and the PFBS 1 decides how to route it, and then functions to post the transaction to preferably an accounting journal (i.e. records of the financial transactions).

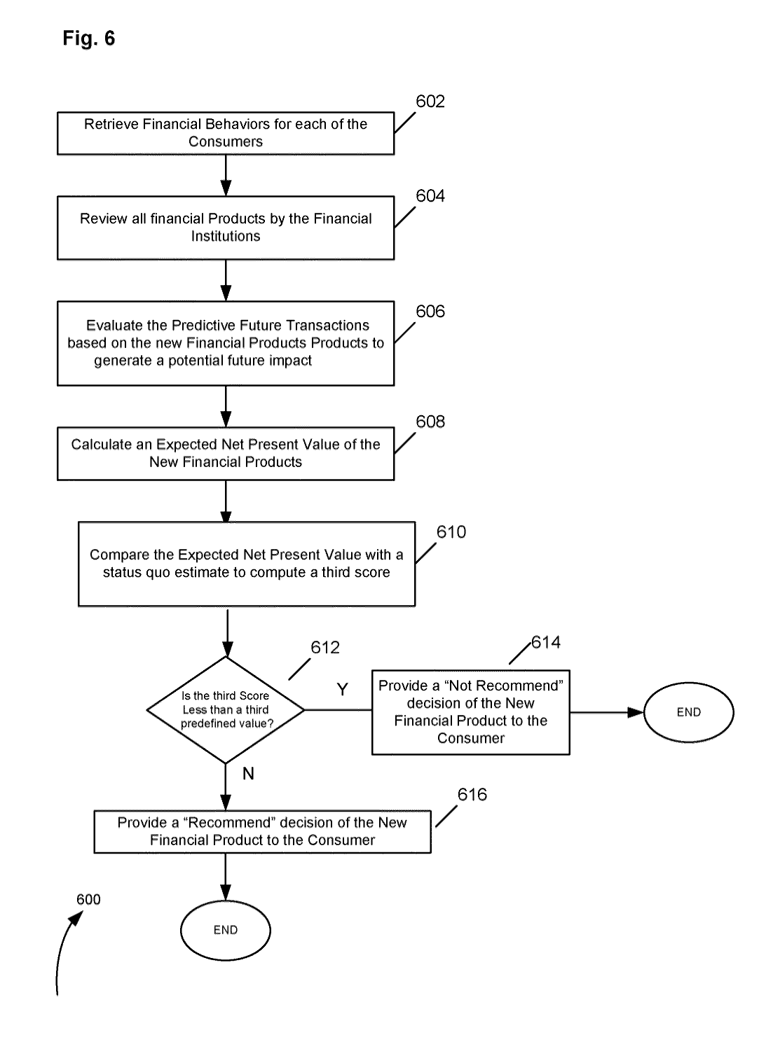

Referring to FIG. 6, there is shown a method 600 for selecting new financial products for consumer s utilizing the future financial behaviors of the consumer stored in the predictive behavior database 108 in accordance with an embodiment of the present application. Beginning with step 602, a financial behavior for each consumer transaction behavior is retrieved by the processor 110 on a periodic basis (e.g. daily, weekly, monthly etc.) from the predictive behavior database 108. In the following step 604, the processor 110 reviews all the financial products (including the terms and conditions of the financial products) provided by the financial institutions 4 to one or more of their consumers. It is noted that all products offered by the financial institutions 4 are not offered to all the consumer s due to regulatory or profitability reasons. For example, a particular credit card may only be available to consumer s with an income greater than a certain level. As such, in step 606, the processor 110 identifies and evaluates the new financial products that are available to the consumer, but he/she does not currently own or use. Specifically, the processor 110 then retrieves the pre-defined coefficients at step 606 and utilizes these coefficients based on the new financial products to simulate or generate another set of predictive future transactions utilizing the method described above with respect to FIG. 2. This simulation results in a prediction of the potential future impact of the new financial products. In step 608, the processor 110 reviews the predicted future transactions and calculates an expected net present value of the new financial product. The net present value is calculated in the same method as described above with respect to FIG. 5. Then, at step 610, the expected net present value is compared with a status quo estimate to compute a third score. In other words, it is determined whether the potential future impact of the new financial product is statistically significantly better for the consumer than the status quo NPV estimate calculated without the addition of any new financial products. Statistical significance is determined based on the probability distribution of the potential future impacts simulated/generated by the processor 110. This determination of significance is made at step 612, where the difference between the NPV estimates is compared against a significance threshold. If at step 612, it is determined that the third score is less than the third pre-defined threshold value, i.e. potential future impact is not statistically significant than the status quo estimate, then at step 614, the PFBS 1 provides a “Not Recommend” decision of the new financial product to the consumer. However, if at step 612, if it is determined that the third score is greater than the third pre-defined threshold value, i.e. potential future impact is statistically significant than the status quo estimate, then the PFBS 1 provides a “Recommend” decision of the new financial product to the consumer at step 614 in order for the consumer to preferably financially benefit from it.

In another embodiment of the present invention, the system may also preferably use the consumers' friends to inform product recommendations. The system may evaluate the success rate of similar product offerings made to the consumer friends while deciding to recommend the financial product to the consumer. So, for example, if the PFBS I recommends a set of financial products to consumer(s) and observes that the consumer(s) actively use those financial products, the PFBS 1 may consider offering those financial products to consumers' friends. Furthermore, the PFBS 1 may evaluate the actual impact of these financial products derived by the consumers' friends who own the financial products, and use this evaluation to update or refine the pre-defined coefficients to adjust the predicted future transactions resulting in more improved and accurate predictive financial behaviors of the consumer.

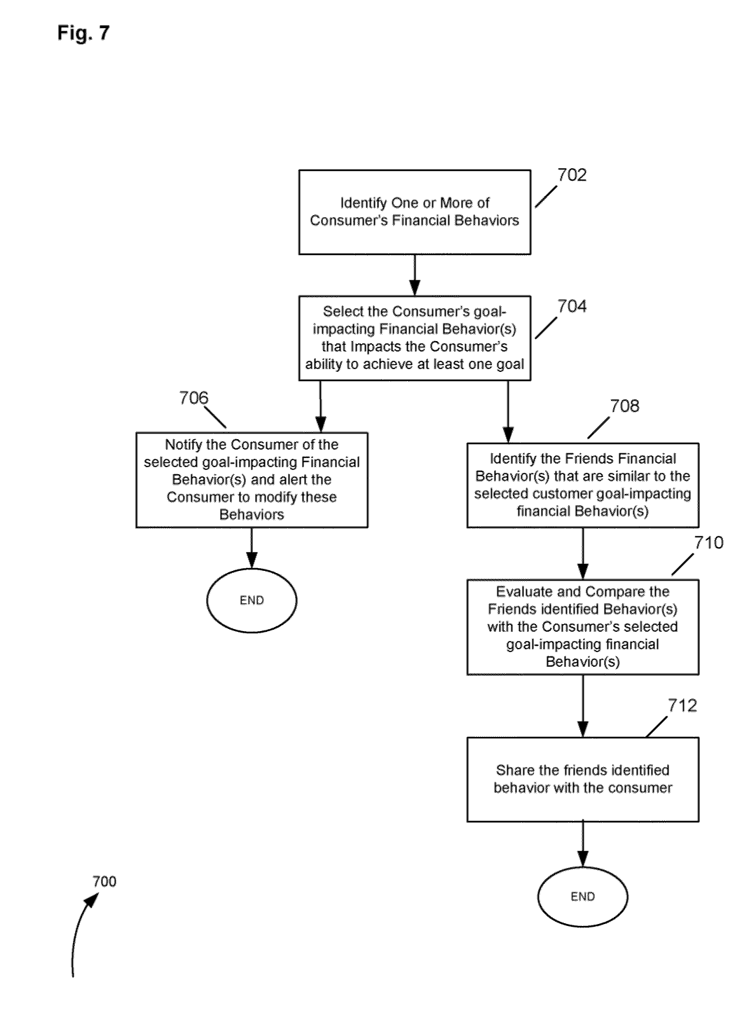

FIG. 7 illustrates a method 700 for assisting consumers in reaching one or more of their financial goals utilizing the predictive behavior database 108 and the social network database 112 in accordance with an embodiment of the present application. Method 700 is described herein based on an example where the consumer's primary financial goal is to increase savings. One having ordinary skill in the art will appreciate that other financial goals may preferably be used in connection with the method 700. Beginning with step 702, the financial behavior processor identifies one or more of consumer's financial behaviors from the predictive behaviors database 108. In this example, the financial behavior processor 110 identifies preferably three of consumer's financial behaviors. For example, a first behavior may represent regular income; a second behavior may represent an annual vacation to a foreign country, while a third behavior may represent a weekend trip to a favorite restaurant. Then, at step 704, the processor 110 selects one or more of these financial behaviors that would impact the consumer's ability to achieve his/her goal of saving money (i.e. goal-impacting financial behavior). For example, the annual vacation and the weekend restaurant trip may be among the consumer's financial behaviors with the biggest expenditures and thus have the greatest impact on the consumer's ability to achieve his or her savings goal. Upon selection of the one or more goal-impacting financial behaviors at step 704, the consumers are notified of these selected goal-impacting financial behaviors and further alerted at step 706 to modify these behaviors in order to strongly impact his/her ability to achieve his/her goal. Further, upon selection of the goal-impacting behaviors at step 704, the financial behaviors of one or more of the consumer's friends (stored in the predictive behavior database 108) that are similar to the consumer's selected goal-impacting behaviors are identified by the processor 110 in step 708. In step 710, the identified friends' financial behaviors are further evaluated and compared with the selected consumer's goal-impacting financial behaviors by the processor 110. So, for example, it may be recognized that while a friend of the consumer share the annual vacation and weekend restaurant trip behaviors, the friend may spend significantly less on these expenditures than the consumer. This may be due to the fact that the friend takes his/her annual vacation within the country, and/or the friend takes public transport to reach her favorite restaurant. In step 712, the financial behaviors of the consumers friends are shared with the consumer for the purpose of achieving his/her goals.

The embodiments described above provide several advantages to the conventional financial systems. One of the advantages is the ability to generate a range of future transactions to estimate how real-time transactions change an individual's future financial needs. Also, the PFBS system 1 is configured to improve its accuracy by using information from other consumers in the system that is matched to the consumer. Another advantage achieved by the embodiments of the present invention is the ability to evaluate expected net present value in order to credibly value existing and alternative behaviors. Furthermore, the system and method of the present invention provide the ability to combine transaction predictions with financial product definitions to facilitate automated transaction routing and further maximize the net present value for the consumer. Another advantage achieved by the embodiments of the present invention is the ability to empower a new set of analytic tools and products in order to enable new behavior formation in the consumers, resulting in the faster achievement of financial goals.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

1. A computer-implemented method for predicting future financial behaviors of a consumer, the method comprising:
(a) receiving a plurality of consumer financial transactions;
(b) identifying a set of similar transactions among the plurality of the consumer financial transactions based on one or more pre-defined coefficients;
(c) clustering the set of similar transactions;
(d) partitioning the consumer financial transactions into a first data set and a second data set, wherein the first data set comprises a first period of the consumer financial transactions and the second data set comprises a second period of the consumer financial transactions;
(e) deriving clustered transactions from the first data set of the financial transactions;
(f) generating random future financial transactions based on transactional details of each of the clustered transactions in the first data set,
(g) comparing transactional details of the random future financial transactions with the transactions in the second data set to compute a first score;
(h) determining that the random future financial transactions comprise predictive future financial transactions if the first score is less than a first pre-defined threshold value;
(i) updating the one or more pre-defined coefficients if the first score is greater than the first predefined threshold value; and
(j) repeating steps (b) through (i).

2. The method of claim 1 wherein the first period comprises a time duration until a pre-defined date and the second period comprise a time duration from the pre-defined date to a current date;

3. The method of claim I wherein the transactional details comprise at least a transaction amount, financial institution of a transaction, original location of a transaction, original location of the consumer, and periodicity between the transactions.

4. The method of claim 1 further comprising retrieving financial transactions of friends of the consumers, wherein the friends comprise an explicit list of friends and an implicit list of friends, wherein the explicit list of friends are identified by the consumer and the implicit list of friends are identified and matched with the consumers based on demographic and behavioral data.

5. The method of claim 4 further comprising comparing the transactional details of the friend financial transactions with the transactional details of the consumer financial transactions to compute a second score.

6. The method of claim 5 further comprising sharing financial behaviors of the friend with the consumer if the second score is less than a second predefined threshold value.

7. The method of claim 6 further comprising updating the pre-defined coefficients if the second score is greater than the second predefined threshold value.

8. The method of claim 1 further comprising receiving an incoming financial transaction of the consumer and evaluating the predicted future financial transactions and associated charges based on routing options of the transactions to one or more of consumer financial products.

9. The method of claim 8 further comprising calculating a net present value of each of the routing options, wherein the net present value is calculated based on the evaluated predicted future transactions and the evaluated associated charges.

10. The method of claim 9 further comprising selecting the routing option based on an expected financial impact of the net present value, wherein the expected financial impact comprise simulated future financial predictions for the routing options based on the calculated net present value.

11. The method of claim 1 further comprising reviewing financial products provided by the financial institutions to identify at least one new financial product, wherein the at least one new financial product is the financial product not currently owned by the consumer.

12. The method of claim 11 further comprising evaluating the predictive future financial transactions based on the new financial product, wherein the evaluating comprising calculating an expected net present value of the new financial product and comparing the expected net present value with a status quo estimate to compute a third score.

13. The method of claim 12 further comprising recommending the new financial product to the consumer if the third score is less than a third-predefined threshold value.

14. The method of claim 6 further comprising identifying at least one financial goal of the consumer and select at least one goal-impacting financial behavior of the consumer, wherein the goal-impacting financial behavior comprise at least one of the financial behaviors of the consumers that impacts financial goal of the consumer.

15. The method of claim 14 further comprising identifying the financial behavior of the friend to match with the selected consumer goal-impacting financial behavior.

16. The method of claim 15 further comprising evaluating to compare the transactional details of the matched friend financial behavior with the transactional details of the selected consumer goal-impacting financial behavior.

17. The method of claim 16 further comprising providing the transactional details of the matched friend financial behavior to the consumer.

18. A system for predicting future financial behaviors of consumers, the system comprising:
a web server for receiving a plurality of consumer financial transactions;
a consumer transaction database coupled to the web server for storing the consumer financial transactions;
(a) identifying a set of similar transactions among the plurality of the consumer financial transactions based on one or more pre-defined coefficients;
(b) clustering the set of similar transactions;
(c) partitioning the consumer financial transactions into a first data set and a second data set, wherein the first data set comprises a first period of the consumer financial transactions and the second data set comprises a second period of the consumer financial transactions;
(d) deriving clustered transactions from the first data set of the financial transactions;
(e) generating random future financial transactions based on transactional details of each of the clustered transactions in the first data set, comparing transactional details of the random future financial transactions with the transactions in the second data set to compute a first score;
(g) determining that the random future financial transactions comprise predictive future financial transactions if the first score is less than a first pre-defined threshold value;
(h) updating the one or more pre-defined coefficients if the first score is greater than the first predefined threshold value; and
(i) repeating steps (a) through (h).
